(19) United States
(12) Patent Application Publication
(10) Pub. No.: US 2022/0350878 A1
(43) Pub. Date: Nov. 3, 2022

(54) SUBSCRIBER AUTHENTICATION RESPONSIVE TO EMERGENCY SERVICES REGISTRATION

(71) Applicant: Payfone, Inc., New York, NY (US)

(72) Inventors: Jeffrey Robert Naujok, Colorado Springs, CO (US); Greg Bonin, Denver, CO (US); Christopher Cunningham, Highlands Ranch, CO (US)

(21) Appl. No.: 17/246,471

(22) Filed: Apr. 30, 2021

(51) Int. Cl. G06F 21/45; H04M 7/00; H04M 3/51; H04L 29/06; H04W 12/06

(52) U.S. Cl. CPC G06F 21/45; H04M 7/006; H04M 3/5116; H04L 63/18; H04W 12/06; H04L 63/08; H04M 2242/04

(57) ABSTRACT

Methods, apparatuses, and/or articles of manufacture may be implemented to authenticate a subscriber of a communications device. The method may include receiving, via a server coupled to a network, a first signal that indicates a modification of one or more location descriptors corresponding to a communications device. The modification may occur in connection with receipt of the one or more location descriptors by an emergency services provider. The method may include storing a record of the modification of the one or more location descriptors in response to creation of one or more new location descriptors corresponding to a subscriber identifier, modification of one or more previously existing location descriptors corresponding to the subscriber identifier, or deletion of the subscriber identifier. The method may additionally include generating a second signal to form or update an electronic or digital identity of the communications device responsive to receiving the first signal.

### BACKGROUND

### 1. Field

The present disclosure relates generally to authentication of a subscriber in possession of, or at least co-located with, an electronic communication device based, at least in part, on the subscriber supplying location descriptors to certain types of services providers, such as emergency services providers.

### 2. Information

The World Wide Web or simply the Web, as enabled by Internet computing, routing, and/or wireless transmission resources, has grown rapidly in recent years at least partially in response to the relative ease by which a wide variety of transactions can be performed or enabled via the Internet. As a consequence of widely available Internet connections, including connections to the Internet facilitated by mobile cellular communication services, for example, a mobile subscriber may shop and/or browse for virtually any product and/or service by way of a handheld communications device. However, in such an environment, in which electronic, Internet-based commerce has become increasingly common, occurrences of fraud and deception, unfortunately, can also occur. To reduce the instances of fraud and deception, fraud-detection and prevention processes may be implemented. Such implementations may be utilized, for example, in connection with numerous types of online or electronic transactions, which may include financial transactions, establishment of lines of credit, in-store purchases for goods and/or services, access to privileged or secure entertainment content, and so forth.

As communications devices, such as smart phones, tablet computing devices, laptop computers, etc., and applications that execute on communications devices, become increasingly sophisticated, techniques for utilizing such devices to commit fraud become correspondingly sophisticated. Sophisticated techniques may involve use and/or knowledge of complex technology, for example, which may be related to the particular hardware and/or software platforms associated with such communications devices. Accordingly, reduction in the instances of fraud and deception, which may involve, for example, use of various electronic devices, continues to be an active area of investigation.

### SUMMARY

One general aspect involves a method that includes receiving, at a server coupled to a network, a first signal indicating an occurrence of a modification of one or more location descriptors corresponding to a communications device. The modification may occur in connection with receipt of the one or more location descriptors by an emergency services provider and storing a record of the modification of the one or more location descriptors. The modification may occur in response to creation of one or more new location descriptors corresponding to a subscriber identifier, modification of one or more previously existing location descriptors corresponding to the subscriber identifier, and/or deletion of the subscriber identifier. The method may also include generating a second signal to form or update an electronic or digital identity of the communications device responsive to receiving the first signal.

In an embodiment, the method may additionally include generating one or more additional signals by the server coupled to the network, in which the one or more additional signals are utilized in a process of authenticating, authorizing, and/or verifying a subscriber conducting an electronic transaction. In an embodiment, the location descriptors indicate a physical address associated with the communications device. In an embodiment the physical address includes a street address. In an embodiment, the communications device corresponds to a mobile cellular communications device, a fixed or mobile voice over internet protocol (VOIP) communications device, or a wireline telephone. In an embodiment the creation of the one or more new location descriptors corresponds to the subscriber identifier is in response to a subscriber entering into an agreement to obtain services from a communication services carrier. In an embodiment the modification of the one or more previously existing location descriptors corresponds to the subscriber identifier is responsive to a subscriber initiating a porting operation to transfer a subscriber identifier from a first communication services carrier to a second communication services carrier. In an embodiment, deletion of the subscriber identifier is responsive to a communication services carrier initiating a service-disconnection event. In an embodiment, the subscriber identifier corresponds to a telephone number of the communications device. In an embodiment, the emergency services provider corresponds to an E911 services provider. In an embodiment, storing the record of the modification of the one or more location descriptors occurs within a time period of between 1.0 seconds and 1.0 hours of the occurrence of the modification.

Another general aspect involves a server, coupled to a communications network, including at least one processor coupled to at least one memory device to initiate reception from the communications network of a first signal to indicate occurrence of a modification of one or more location descriptors corresponding to a communications device. The modification of the one or more location descriptors may be in connection with receipt of the one or more location descriptors by an emergency services provider. The at least one processor coupled to the at least one memory device may additionally initiate storage of a record of the modification of the one or more location descriptors, the modification occurring in response to at least one of: creation of one or more new location descriptors corresponding to a subscriber identifier; modification of one or more previously existing location descriptors corresponding to the subscriber identifier; or deletion of the subscriber identifier. The processor coupled to the at least one memory device may additionally generate a second signal to form or update an electronic or digital identity of the communications device responsive to receipt of the first signal.

In an embodiment, the one or more location descriptors may indicate a street address. In an embodiment, the communications device corresponds to a mobile cellular communications device or to a VOIP communications device. In an embodiment, the creation of the one or more new location descriptors corresponding to the subscriber identifier is responsive to a subscriber entering into an agreement to obtain services from a communication services carrier. In an embodiment, the modification of the one or more previously existing location descriptors corresponding to the subscriber identifier is in response to a subscriber initiating an operation to port the subscriber identifier from a first communication services provider to a second communication services provider. In an embodiment, deletion of the subscriber identifier corresponds to a communication services carrier initiating a service-disconnection event. In an embodiment, the subscriber identifier corresponds to a telephone number of the communications device. In an embodiment, the emergency services provider corresponds to an e911 services provider. In an embodiment, storage of the record of the modification of the one or more location descriptors occurs within a time period of between 1.0 seconds and 1.0 hours after the modification of the one or more location descriptors.

Another general aspect relates to an article that includes a non-transitory storage medium having instructions stored thereon executable by a special-purpose computing platform. The instructions are to initiate reception, from a communications network, of a first signal indicating occurrence of a modification of one or more location descriptors corresponding to a communications device. The modification may occur in response to receipt of the one or more location descriptors by an emergency services provider. The instructions may initiate storage of records corresponding to the modification of the one or more location descriptors. The modification may occur in response to creation of one or more new location descriptors corresponding to a subscriber identifier, modification of one or more previously existing location descriptors corresponding to the subscriber identifier, or deletion of the subscriber identifier. The stored instructions may additionally bring about the generation of a second signal to form or update an electronic or digital identity of the communications device responsive to receipt of the first signal.

In an embodiment, the stored instructions may bring about creation of the one or more new location descriptors corresponding to the subscriber identifier responsive to a subscriber entering into an agreement to obtain services from a communication services carrier. In an embodiment, the stored instructions may bring about modification of the one or more previously existing location descriptors corresponding to the subscriber identifier in response to a subscriber initiating an operation to port the subscriber identifier from a first communication services provider to a second communication services provider. In an embodiment, the stored instructions may bring about deletion of the subscriber identifier corresponds to a communication services carrier initiating a service-disconnection event.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a diagram of a communications infrastructure that includes both wireless and wireline communications devices, according to various embodiments.

FIG. 2A shows a subscriber in possession of a communications device to permit registration of the communications device with an emergency services provider, according to an embodiment.

FIG. 2B shows records stored within or accessible to the client server and the authentication server of FIG. 2A, according to an embodiment.

FIG. 3 is a diagram showing signal flow among a communications device, a services carrier, and emergency services provider, and authenticator, according to an embodiment.

FIG. 4 is a flowchart showing operations performed by an authentication server that may access a subscriber database, according to an embodiment.

FIG. 5 is a diagram showing a computing environment, according to an embodiment.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases in various places throughout this specification, are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, for the specification of a patent application, these and other issues have a potential to vary in a particular context of usage. In other words, throughout the disclosure, particular context of description and/or usage provides guidance regarding reasonable inferences to be drawn; however, likewise, the term “in this context” in general without further qualification refers at least to the context of the present patent application.

As previously alluded to, in an environment in which electronic communication devices, such as mobile cellular communications devices, voice over Internet protocol (VoIP) communications devices, tablet computing devices etc., are increasingly prevalent, a user of an electronic communications device may wish to perform an electronic or digital transaction involving or utilizing such devices. Such transactions may involve completing applications for credit, engaging in electronic financial transactions, purchasing products and/or services, obtaining access to privileged entertainment content, completing loan applications, completing forms involved with applying for healthcare coverage (such as in connection with visiting a health provider's office or website), and/or engaging in a number of other types of transactions via a communications device. To facilitate these and other types of transactions, a subscriber in possession of, or at least co-located with, a communications device may establish an electronic or digital identity, such as may be established in connection with a communications device subscriber account with a cellular or mobile communications services carrier, a VoIP services provider, or other type of communication services carrier. Establishing an account associated with a communications device, utilizing, for example, a subscriber account identifier (e.g., a cellular telephone number), may permit an individual attempting to engage in an electronic or digital transaction to be authenticated, authorized, and/or verified prior to engaging in the transaction. In some instances, in view of the nature of electronic or digital transactions, such as in an environment in which electronic or digital transactions can be conducted utilizing a communications network at any time and at any location, it may be useful to verify and/or authenticate a subscriber relatively quickly, such as in a real-time fashion, for example.

As a general matter, authentication or verification of a subscriber operating, or at least co-located with, a communications device may be desirable in response to a client institution or organization (e.g., a financial institution, a brokerage, a healthcare provider, an entertainment content provider, etc.) seeking to determine and/or prove identity of the transacting party. Verification and/or authorization of a subscriber co-located with a communications device may involve establishing a correspondence between the real-world identity of the subscriber and a subscriber account identifier, which may exist in an electronic or digital domain. In this context, correspondence, association, and/or similar terms, refers to a persistent, continuing, and objectively verifiable relationship between the subscriber (or other transacting party) in possession of, or co-located with, a particular communications device, such as a mobile communications device. Thus, a unique subscriber account identifier may be employed to signify and/or identify a particular transacting party. In this context, the term “mobile communications device identity” and/or similar terms refer to an identity that leverages a mobile communications device account relationship of a subscriber as a source of authentication and/or verification of a transacting party. Also in this context, the term “mobile subscriber device account” and/or similar terms refer to a mobile communication services provider account. The terms “mobile communications device services provider,” “mobile communications device carrier,” and “mobile network operator” may be used interchangeably. Furthermore, in this context, the term “mobile device services carrier” or “communication services carrier” may refer to an entity operating within a communications infrastructure to provide wired and/or wireless communication services to the public for a consideration, such as a monthly subscription fee.

Likewise, the terms “emergency services carrier” or “emergency services provider” refers to an entity coupled to the communication infrastructure that provides dispatch of emergency-related resources, such as ambulances, police, fire, and so forth. In some countries, such emergency services may be obtained via entry, of a three-digit number, such as “911,” utilizing a user interface (e.g., dialing a telephone number). In other instances, emergency services may be obtained utilizing other three-digit combinations, such as “999” and the United Kingdom, “112,” in France, Germany, and at other locations on the European continent, and so forth. In some instances, entry of such three-digit combinations utilizing a communications device, such as a mobile, VoIP, or wireline communications devices brings about an immediate dispatch of emergency resources with or without the emergency services provider receiving explicit instructions to dispatch such resources.

In the context of the present disclosure, a “communication services carrier” may refer to a mobile communication services provider and/or mobile network operator. However, there are examples of carriers that do not correspond to mobile communications device services providers and/or mobile network operators. Such instances may include wireline services providers (for example, providers of services operating within the public switched telephone network or PSTN), which include wireline services for rotary-dial telephones and/or telephones utilizing, for example, dual tone multi-frequency (DTMF) signaling. In a given situation, particular context of usage should indicate if a term is being used in a general sense or in a narrower sense, such as referring to a mobile communications device services provider, wireline services provider, mobile paging services provider, and/or mobile network operator, for example.

Other aspects of verifying and/or authenticating a mobile subscriber, such as by way of proving that a particular mobile subscriber is in possession of, or at least co-located with, a communications device, are also described in greater detail hereinbelow. For example, in an embodiment, verifying the identity and/or authenticating a subscriber may relate to a mobile subscriber account. Further, a mobile subscriber account is merely an example of a type of subscriber account, especially in a networked electronic commerce environment, although claimed subject matter is not intended to be limited to online accounts or to mobile accounts. Rather, the term “account” or “subscriber account” in this context refers generally to a formal business arrangement between a provider of the account and an entity, a person, or other party seeking to obtain privileges associated with the account. Thus, the term “account” is intended to be broadly interpreted as an arrangement that may provide certain privileges. In this context, privileges may involve access to credit (e.g., so as to facilitate the purchase of goods or services), access to premium entertainment content (e.g., premium sports, cinema, or other entertainment content), access to health records, access to financial records, access to financial and/or brokerage accounts, or any other type of access to secure content. In this context, the term “secure content” is intended to be interpreted broadly so as to encompass any type of content available exclusively to certain individuals and/or certain entities in response to supplying certain credentials.

In this context, the term “subscriber account identifier” refers to a unique indicator or feature associated with the account that defines certain aspects of the account. For example, in nonlimiting illustrations, a subscriber account identifier may refer to (or may at least be associated with) a mobile telephone number, a mobile subscriber unique alias, an International Mobile Subscriber identifier (IMSI), an Integrated Circuit Card Identifier (ICC ID), a mobile services and/or other type of identifier (e.g., a unique identifier) employed in connection with the particular mobile network operator or the mobile communication services provider. Mobile communications networks may include those compatible or compliant with a Global System for Mobile Communications (GSM) telecommunications network, for example. Other examples of mobile subscriber account identifiers may include an International Mobile Equipment Identifier (IMEI), Mobile Station International Subscriber Directory Number (MSISDN), a mobile equipment identifier or any other identifier that may be utilized to identify a mobile billing account number/identifier.

As discussed herein, a subscriber co-located with, or in possession of, a communications device may apply for an account, such as a credit account, for example, or may apply for any other type of account that imparts or confers particular privileges on the subscriber co-located or in possession of the communications device. In other instances, a subscriber co-located with a mobile device may attempt to engage in a financial transaction, for example, or may attempt to access privileged information/secure content, just to name a few examples. In many instances, to obtain privilege, such as access to credit, access to security content (e.g., streaming premium content or other privileged entertainment content) a mobile subscriber may be required to complete an application, such as an application for an account, an application for credit, an application for an increase in credit, or may be required to make another type of formal request, which involves the subscriber supplying subscriber-specific parameters. However, as previously alluded to, it may be advantageous for the subscriber, and for the institution providing privileges to the subscriber, for example, to verify or prove that, indeed, the subscriber is co-located with (or is in possession of) a particular communications device. By proving possession of a particular communications device, an institution may reduce the risk of an unscrupulous individual, for example, engaging in fraudulent behavior by impersonating a particular mobile subscriber. Such fraudulent behavior may be made possible by an unscrupulous individual stealing another subscriber's mobile phone or identity, or by way of obtaining secure content that permits the unscrupulous individual to impersonate another subscriber.

Thus, in particular embodiments, authenticating a particular subscriber in possession of, or at least co-located with, a communications device may permit and authenticating entity to prove that a specific individual is attempting to engage in a transaction that involves secure content. Obtaining such proof may reduce the likelihood of an unscrupulous individual completing a fraudulent transaction, such as a transaction involving credit applications, increases in credit lines, purchases, asset sales, access to premium entertainment content, or the obtaining of any other type of privileges via fraud and/or deception. In particular embodiments, proving that a particular subscriber is in possession of, or at least co-located with, a communications device may involve an authentication server receiving a signal that includes metadata relevant to location descriptors corresponding to the subscriber following (or, in some cases immediately following) activation of a communications device by the subscriber. Thus, for example, prior to a activation of a subscriber communications device, location descriptors, such as a street address, or other physical address parameters, may be registered with an emergency services provider. In particular embodiments, metadata with respect to certain subscriber parameters, such as metadata concerning location descriptors corresponding to a subscriber identifier, may be passed to an authentication server, thereby notifying the authentication server that a modification has been made to a record associated with or corresponding to the subscriber identifier. In this context, the term “immediately following” refers to an occurrence that transpires at a time greater than 1.0 seconds but less than 1.0 hours after the occurrence of a former event. Accordingly, in particular instances, responsive to a subscriber attempting to engage in a financial transaction, a comparison of a subscriber name, identifier (e.g., mobile telephone number), and location descriptors obtained by the financial institution, with corresponding records accessible to an authentication server may be utilized to determine whether the financial transaction is to be approved. Approval of a financial transaction may be based, at least in part, on subscriber parameters obtained by the financial institution (e.g., subscriber name, subscriber identifier, physical address or other type of location descriptors) matching corresponding subscriber parameters accessed by an authentication server.

Accordingly, it may be advantageous for an authentication server to obtain a notification signal (e.g., metadata) that subscriber parameters, such as location descriptors corresponding to a particular subscriber, have been modified. In particular embodiments, a notification signal (e.g., metadata) may be conveyed to an authentication server immediately following activation of a services account in connection with a communications device. In some instances, in the course of activating a subscriber communication services account, the subscriber may be required to supply location descriptors, such as a physical, street address or other type of address. Such location descriptors may be supplied in connection with registering a communications device to permit a subscriber to obtain, for example, E911 emergency services. In particular jurisdictions, supplying of such location parameters may permit emergency service resources to be dispatched to aid a subscriber, potentially in distress, utilizing the provided location descriptors. In particular jurisdictions, supplying of such location parameters may be mandatory and may be required to coincide with activation of a services account in connection with a communications device.

In particular embodiments, an authentication server may receive and/or obtain a notification signal (e.g., metadata) that location descriptors corresponding to a particular subscriber identifier (e.g., mobile telephone number) have been modified. Such modifications may be supplied prior to activation of an account with a communication services carrier in compliance with E911 emergency services directives. Newly-supplied location descriptors corresponding to a particular subscriber identifier may be utilized as a means of notifying an authentication server that location descriptors supplied in connection with E911 compliance may differ from location descriptors stored in a database accessible to the authentication server. The potential for such differences between newly-supplied location descriptors and previously-stored location descriptors may serve as an indicator of the presence of potential fraud. An indication of potential fraud may be utilized, for example, by a bank or other financial institution considering extending credit, for example, to a subscriber. In addition, responsive to a subscriber identifier and location descriptors being supplied upon (or prior to) activation of a services account in connection with a communications device, metadata concerning location descriptors may be corresponding to a subscriber identifier may be immediately made available to an authentication server. Thus, an authentication server may, in a real-time or near-real-time fashion, be capable of providing an alert to an institution, such as a financial institution, that location descriptors (e.g., a physical address) of a subscriber cannot be verified or cannot be verified with a level of confidence that meets or exceeds a lower threshold. Based, at least in part, on such signaling from an authentication server, a financial institution may elect to terminate an initiated transaction.

In particular embodiments, in addition to location descriptors being supplied in connection with a newly activated communications device, location descriptors may be modified following (e.g., immediately following) modification of a previously existing subscriber identifier (e.g., a mobile cellular telephone number). For example, responsive to a subscriber registered as residing at a particular physical address obtaining a different identifier corresponding to a communications device, such modifications may be reported to an E911 emergency services provider. Accordingly, in response to a change in location descriptors corresponding to a subscriber identifier, an authentication server may be notified that such location descriptors have been modified. Hence, perhaps in response to a subscriber attempting to engage in a financial transaction, an authentication server may immediately perform a comparison between a first data set that includes one or more newly-entered location descriptors and a second data set of location descriptors currently stored within, or accessible to, the authentication server.

In some instances, an emergency services provider (e.g., an E911 emergency services provider) may receive notification upon or prior to a termination of service in connection with a particular subscriber identifier. In some instances, a return of a subscriber identifier in response to a service-disconnection event, such as, for example, a “snapback” event. In these instances, a particular subscriber identifier (e.g., a mobile telephone number) may no longer correspond to. And/or be associated with, a particular subscriber and/or corresponding set of location descriptors. Thus, an unscrupulous individual may be precluded from completing a fraudulent transaction, for example, utilizing a subscriber identifier (e.g., a mobile telephone number) that has undergone a snapback event or any other type of service-disconnection event. In such instances, following, such as immediately following, a snapback event (for example), an authentication server may be immediately notified, such as within an hour of a snapback or other type of service-disconnection event. Such timely notification of a snapback or other service-disconnection event may serve to immediately inform an authentication server that a subscriber who is attempting to engage in a transaction utilizing a particular communications device may, in fact, be attempting to engage in a fraudulent transaction.

Responsive to an authentication server having authenticated and/or verified a subscriber, or otherwise confirmed that a particular subscriber that corresponds with particular location descriptors is, indeed, in possession of (or at least co-located with) a particular communications device, a financial institution, for example, may be confident that a verified and/or authenticated individual is attempting to engage in a transaction. Conversely, as noted above, in response to an authentication server determining that a particular subscriber could not be authenticated and/or verified, a financial institution, for example, may elect to deny the purported subscriber from engaging in a financial transaction, for example.

Thus, particular embodiments of claimed subject matter may allow providers of secure content, such as financial institutions, to be assured that an unscrupulous individual, who might attempt to impersonate a particular subscriber, for example, cannot complete a financial transaction. In other instances, a provider of secure content can be assured that an unauthorized user cannot access secure content, such as financial records, health records, premium content, or any other form of secure content. In many instances, preventing unscrupulous individuals from engaging in fraudulent financial transactions, for example, such as by way of the fraudulent impersonation of a particular communications device account holder, operates to protect authentic account holders as well as financial institutions, providers of premium entertainment content, healthcare institutions, and so forth. In addition, following authentication of a particular subscriber, such as by way of proving that the subscriber is (indeed) in possession of a specific communications device, particular embodiments of claimed subject matter may permit an authentication service to report to a financial institution, for example, a measure of trust and/or trustworthiness of a particular communications device. By way of reporting trust and/or trustworthiness of a subscriber to a financial institution, certain types of transactions may be permitted to occur while other types of transactions may be denied. Preventing fraudulent transactions may bring about a reduction in instances of identity theft, fraud related to credit cards and/or other instruments, circumventing of parental controls, pirating of exclusive entertainment content, and so forth.

As previously noted, in particular embodiments, after verification of the identity of a particular communication services subscriber, an identity verifier may access a data store to determine a reputation with respect to a communications device. In particular embodiments, a reputation with respect to a communications device may be negatively impacted (e.g., degraded) responsive to the communications device being associated with one or more risk events. Such risk events may include, but are not limited to, detecting new or updated location descriptors for a corresponding subscriber, deletion of a subscriber identifier responsive to a service termination, recent porting of a subscriber account identifier (e.g., a telephone number) associated with a communications device, recent replacement of a communications device, a recent request of a one-time-password associated with a communications device, removal/replacement of a SIM of a communications device, as well as any number of additional risk events associated with the device. In particular embodiments, a reputation of a communications device may be positively impacted (e.g., enhanced) responsive to detecting an absence of new or updated descriptors for a subscriber of a corresponding communications device, a communications device having never been ported (or having not been ported for a prolonged period of time), a communications device having never undergone removal/replacement of a SIM (or having not undergone such removal/replacement of a SIM for a prolonged period of time), and so forth. It should be noted that claimed subject matter is intended to embrace risk events with respect to a communications device other than these, virtually without limitation.

Although the discussion that follows relates to any type of account, in nonlimiting illustrations, accounts corresponding to communications devices may be used for illustration. However, it is understood that claimed subject matter is intended to not be limited to examples provided primarily for purposes of illustration, since such examples may be oversimplified for purposes of comprehension, for example.

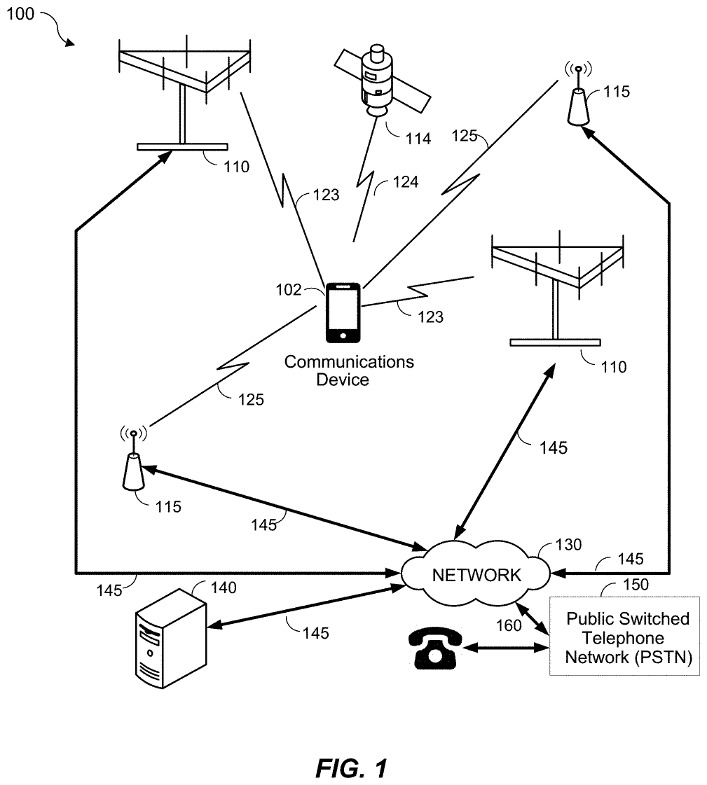

FIG. 1 is a diagram of a communications infrastructure that includes both wireless and wireline communications devices, according to various embodiments. In FIG. 1 (embodiment 100) communications device 102 may transmit radio signals to, and receive radio signals from, a wireless communications network. In an example, communications device 102 may communicate with a cellular communications network by transmitting wireless signals to, and/or receiving wireless signals from, a cellular transceiver 110, which may comprise a wireless base transceiver subsystem, a Node B or an evolved NodeB (eNodeB), over wireless communication link 123. Similarly, communications device 102 may transmit wireless signals to, and/or receive wireless signals from, local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed herein). Of course, it should be understood that these are merely examples of networks that may communicate with a mobile device over a wireless link, and claimed subject matter is not limited in this respect. In particular embodiments, cellular transceiver 110, local transceiver 115, satellite 114, and PSTN 150 represent touchpoints, which permit communications device 102 to interact with network 130.

Examples of network technologies that may support wireless communication link 123 are GSM, Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). In the embodiment of FIG. 1, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, BT and LTE.

In a particular implementation, cellular transceiver 110 and local transceiver 115 may communicate with server 140, such as by way of network 130 via communication links 145. Here, network 130 may comprise any combination of wired or wireless links and may include cellular transceiver 110 and/or local transceiver 115 and/or server 140. In a particular implementation, network 130 may comprise Internet Protocol (IP) or other infrastructure capable of facilitating communication between communications device 102 at a call source and server 140 through local transceiver 115 or cellular transceiver 110. In an embodiment, network 130 may also facilitate communication between communications device 102, server 140 and a PSTN 150, for example through communications link 160. In another implementation, network 130 may comprise a cellular communication network infrastructure such as, for example, a base station controller or packet based or circuit based switching center (not shown) to facilitate mobile cellular communication with communications device 102. In a particular implementation, network 130 may comprise local area network (LAN) elements such as WiFi APs, routers and bridges and may, in such an instance, comprise links to gateway elements that provide access to wide area networks such as the Internet. In other implementations, network 130 may comprise a LAN and may or may not involve access to a wide area network but may not provide any such access (if supported) to communications device 102. In some implementations, network 130 may comprise multiple networks (e.g., one or more wireless networks and/or the Internet). In one implementation, network 130 may include one or more serving gateways or Packet Data Network gateways. In addition, one or more of server 140 may comprise an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 130.

In particular embodiments, communications between communications device 102 and cellular transceiver 110, satellite 114, local transceiver 115, and so forth may occur utilizing signals communicated across wireless communications channels. Accordingly, the term “signal” may refer to communications utilizing propagation of electromagnetic waves across wireless communications channels. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in a signal using one or more of the above-identified modulation techniques.

In particular implementations, and as discussed below, communications device 102 may comprise circuitry and processing resources capable of obtaining location related measurements (e.g. for signals received from GPS or other Satellite Positioning System (SPS) satellites 114), cellular transceiver 110 or local transceiver 115 and possibly computing a position fix or estimated location of communications device 102 based on these location related measurements. In some implementations, location related measurements obtained by communications device 102 may be transferred to a location server such as an enhanced serving mobile location center (E-SMLC) or SUPL location platform (SLP) (e.g. which may comprise a server, such as server 140) after which the location server may estimate or determine an estimated location for communications device 102 based on the measurements. In the presently illustrated example, location related measurements obtained by communications device 102 may include measurements of signals 124 received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110).

Communications device 102 or a separate location server may obtain a location estimate for communications device 102 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at communications device 102 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at communications device 102. Here, server 140 may be capable of providing positioning assistance data to communications device 102 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, server 140 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, communications device 102 may obtain measurements of signal strengths for signals received from cellular transceiver 110 and/or local transceiver 115 and/or may obtain a round trip signal propagation time (RTT) between communications device 102 and a cellular transceiver 110 or local transceiver 115. A communications device 102 may use these measurements together with assistance data (e.g. terrestrial almanac data or GNSS satellite data such as GNSS Almanac and/or GNSS Ephemeris information) received from server 140 to determine a location estimate for communications device 102 or may transfer the measurements to server 140 to perform the same determination. A call from communications device 102 may be routed, based on the location of communications device 102, and connected to PSTN 150, for example, via wireless communication link 123 and communications link 160.

A mobile device at a call source (e.g., communications device 102 of FIG. 1) may be referred to by any name corresponding to a cellphone, smartphone, laptop, tablet, PDA, tracking device or some other portable or movable device. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network where a user may employ audio, video and/or data I/O devices and/or body sensors and a separate wireline or wireless modem. An estimate of a location of a mobile device (e.g., communications device 102) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level).

Communications device 102 may also include a sensor suite, which may, for example, include inertial sensors and environment sensors. Inertial sensors of communications device 102 may comprise, for example accelerometers (e.g., collectively responding to acceleration of communications device 102 in and x-direction, a y-direction, and a z-direction). Communications device 102 may further include one or more gyroscopes or one or more magnetometers (e.g., to support one or more compass applications). Environment sensors of communications device 102 may comprise, for example, temperature sensors, barometric pressure sensors, ambient light sensors, camera imagers, microphones, just to name few examples. Sensors of communications device 102 may generate analog or digital signals that may be stored in utilizing one or more memory locations internal to device 102 in support of one or more applications such as, for example, applications collecting or obtaining biometric attributes of a user (e.g., a subscriber) of communications device 102.

The architecture of the cellular communications network described in relation to FIG. 1 may comprise a generic architecture that is capable of accommodating a variety of outdoor and indoor location solutions including the standard SUPL user plane location solution defined by the Open Mobile Alliance (OMA) and standard control plane location solutions defined by 3GPP and 3GPP2. For example, server 140 may function as (i) a SUPL location platform to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

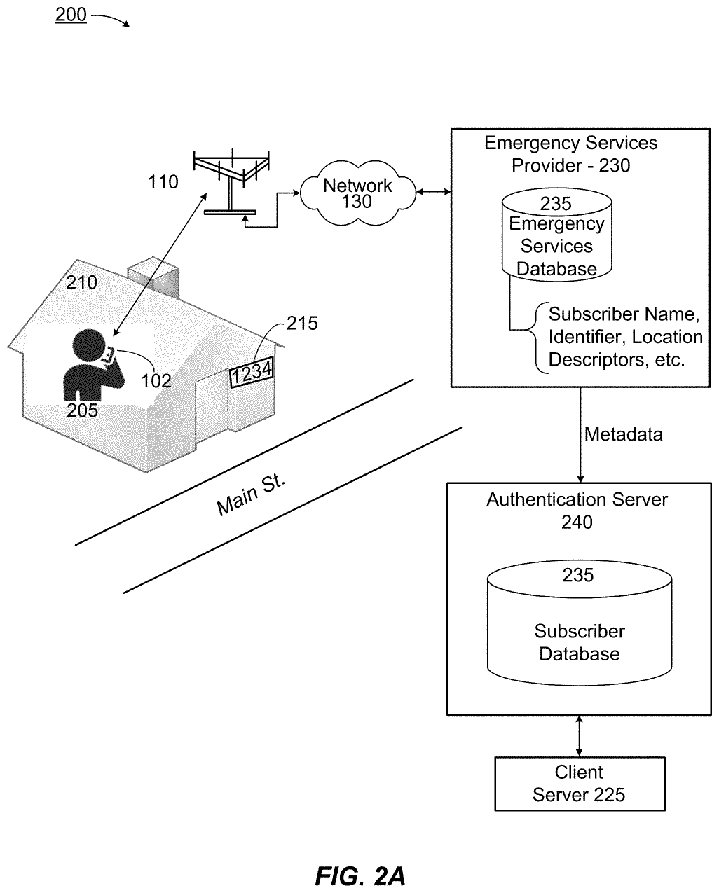

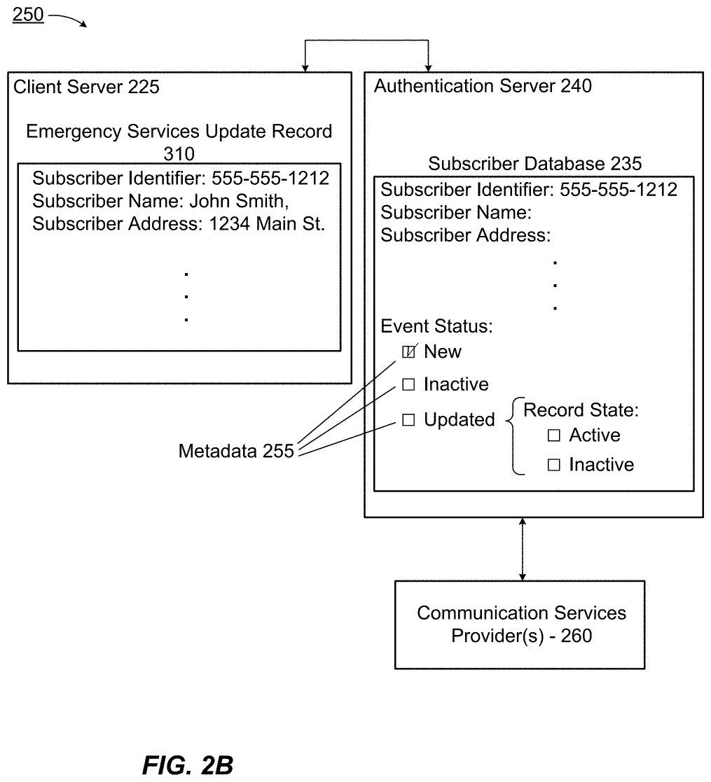

In view of the communications infrastructure shown and described in reference to FIG. 1, more particular embodiments are directed toward subscriber authentication responsive to emergency services registration. Thus, FIG. 2A shows a subscriber in possession of a communications device to bring about registration of the communications device with an emergency services provider, according to an embodiment 200. In the embodiment of FIG. 2A, mobile subscriber 205, located within dwelling 210, may be positioned at any location within wireless communications range of cellular transceiver 110. As shown in FIG. 2A, communications device 102 may communicate with emergency services provider 230 via network 130 utilizing a wireless communications channel formed between the communications device and cellular transceiver 110. It should be noted, however, that claimed subject matter is not limited to wireless communications between device 102 and cellular transceiver 110. For example, in particular embodiments, communications device 102 may communicate with emergency services provider 230 by way of one or more intervening Wi-Fi networks or by way of wireline telephone services (e.g., the public switched telephone network).

In the embodiment of FIG. 2A, prior to a telecommunication services provider activating a subscriber account, subscriber 205 may be requested to enter, upload, or otherwise convey location descriptors to emergency services provider 230. In some instances, such entering, uploading, or conveying of location descriptors to emergency services provider 230 may occur as a condition of obtaining wireless services from a communication services provider. In the example of FIG. 2A, subscriber 205 may be requested to enter one or more descriptors, such as by way of a user interface of communications device 102, corresponding to a street address, such as “1234” identified in placard 215 affixed to dwelling 210. In addition to entering a location descriptor corresponding to a street address, for example, subscriber 205 may additionally be requested to enter a street name, also by way of a user interface of the device 102 such as “Main St.” shown in FIG. 2A. Subscriber 205 may further be requested to enter additional location descriptors via a user interface of communications device 102, such as a city or town within which dwelling 210 is positioned, a ZIP Code, a state or other type of principality, country, etc., and claimed subject matter is not limited in this respect.

Emergency services provider 230 may correspond to any type of emergency services dispatch, such as in connection with, for example, an E911 services provider operating within the United States. In this example, in response to subscriber 205 operating communications device 102 entering a three-digit combination, such as “911,” emergency services provider 230 may be utilized to coordinate emergency resources, such as police, fire, ambulance, and so forth. In other embodiments, emergency services may be obtained utilizing other three-digit combinations, such as “999” in the United Kingdom, “112” in France, Germany, and in other countries of the European continent, and so forth. In some instances, entry of such three-digit combinations utilizing a communications device, such as a mobile, VoIP, or wireline communications device, brings about an immediate dispatch of emergency resources with or without the emergency services provider receiving explicit instructions to deliver such resources. Such services may be intended to provide aid to subscriber 205 who may potentially be in distress.

As indicated in FIG. 2A, upon or immediately following, receipt of location descriptors from subscriber 205, entered via communications device 102, emergency services provider 230 may communicate with authentication server 240. Communication with authentication server 240 may permit a transfer of metadata with respect to a subscriber identifier of communications device 102 (e.g. a mobile telephone number). A signal comprising metadata may be in the form of an event flag or other type of semaphore to indicate, for example, that a new or unrecognized communications device is associated with the location coordinates of dwelling 210. In turn, authentication server 240 may record and/or store the metadata, which may operate to inform the authentication server perform further actions, as described in greater detail in reference to FIG. 2B. Signals comprising metadata, such as in the form of one or more event flags, may indicate to authentication server 240 that communications device 102 represents a new device (e.g., and unknown device being registered for the first time with an emergency services provider) or an updated device (e.g., a previously known device for which a subscriber identifier, or other parameter, has been modified). In particular embodiments, signals comprising metadata conveyed from emergency services provider 230 to authentication server 240 may also include an indication that a communication services provider has terminated (e.g., disconnected) service to communication device 102.

FIG. 2B (embodiment 250) shows records stored within or accessible to the client server and the authentication server of FIG. 2A, according to an embodiment. As indicated in FIG. 2B, emergency services update record 310 may be stored within, or accessible to, client server 225. Emergency services update record 310 may be created responsive to subscriber 205 attempting to obtain services from a communication services provider. As shown in FIG. 2B, emergency services update record 310 may include the full name of subscriber 205, location descriptors (e.g. street address, city or township, state, country, etc.) of subscriber 205, as well as a host of additional parameters requested by client server 225.

In an embodiment, perhaps in response to subscriber 205 attempting to obtain credit at a later date, client server 225 may communicate with authentication server 240 in an attempt to authenticate and/or verify parameters entered by subscriber 205 on a credit application, application to access preferred content, or the like. Thus, as shown in FIG. 2B, authentication server 240 may access subscriber database 235 so as to determine the authenticity and/or validity of parameters entered on, for example, the credit application. However, as is also shown in FIG. 2B, a subscriber name, address, and perhaps a variety of additional parameters are not present (or are at least not accessible to) authentication server 240. Subscriber database 235 may additionally indicate metadata 255, such as whether an event status of “New,” “Inactive,” or “Updated” has been posted in relation to subscriber identifier 555-555-1212. Thus, in response to an absence of parameters associated with or corresponding to the subscriber identifier, authentication server 240 may be unable to authenticate subscriber 205. In such instances, authentication server 240 may obtain location descriptors of subscriber 205 (e.g., street address, city or township, state, country, etc.) in response to one or more queries to a corresponding number of communication services carriers 260. Responsive to obtaining location descriptors from the communication services carrier, authentication server 240 may be capable of comparing location descriptors from emergency services update record 310 with descriptors obtained from the communication services carrier.

In some embodiments, metadata 255 may indicate an event status of “Inactive” in response to the subscriber identifier 555-555-1212 corresponding to a communications device for which a communication services carrier has terminated service (e.g., disconnected). In such an instance, authentication server 240 may recognize that a particular subscriber identifier is no longer active. In some instances, an event status of “Inactive” may be indicative of an unscrupulous individual attempting to fraudulently complete a credit application utilizing a subscriber identifier (e.g., mobile telephone number) that has been disconnected by a communication services carrier. Thus, it may be appreciated that the posting of an event status of “Inactive” may assist an authentication server in determining potentially fraudulent behavior. An event status of “Inactive” in this context may bring about other benefits, and claimed subject matter is not limited in this respect.

In some embodiments, metadata 255 may indicate an event status of “Updated” in response to a subscriber identifier having been updated. In particular instances, an event status of “Updated” may imply that a previously known communications device has undergone one or more parameter modifications. In this context, a status event of “Updated” may be accorded in response to subscriber 205 recently porting a subscriber identifier (e.g., telephone number) corresponding to a communications device, such as from a first communication services carrier to a second communication services carrier. In such an instance, metadata 255 may indicate a “Record State” of “Active,” which may be indicative of a recent porting of the subscriber identifier. Hence, authentication server 240 may transmit a query to subscriber database 235, so as to determine if the subscriber identifier (e.g., 555-555-1212) corresponds to a currently active subscriber. Responsive to the database query indicating that subscriber 205 is currently active, authentication server 240 may perform an update to the appropriate record within subscriber database 235. In some instances, an update to the appropriate record may occur in response to authentication server 240 transmitting a query to a communication services carrier(s) 260 to determine current location descriptors (e.g., street address, city or township, state, country, etc.) corresponding to subscriber 205.

In other instances, metadata 255 indicates an event status of “Updated,” which, again, may imply that it previously known communications device has undergone one or more parameter modifications. However, responsive to metadata 255 indicating a Record State of “Inactive,” authentication server 240 may determine that subscriber 205 corresponds to a different subscriber than a subscriber who previously possessed or was otherwise associated with communications device 102. In such an instance, authentication server 240 may determine that subscriber 205 may be attempting to impersonate a previous subscriber, so as to, for example, obtain credit utilizing the credentials of the previous subscriber.

Thus, it may be appreciated that the use of metadata 255 facilitates an authentication and/or validation approach in which, for a particular phone number, it can be determined if communications device 102 is currently active or currently inactive and, in addition, which communication services carrier is currently providing services to the communications device. Accordingly, the particular communication services carrier can be queried and, in response to one or more queries, location descriptors of subscriber 205 (operating communications device 102) can be transmitted to the authentication server. In turn, the authentication server may be capable of comparing subscriber location descriptors, extracted from a communication services carrier, with location descriptors provided by, for example, an individual completing credit application.

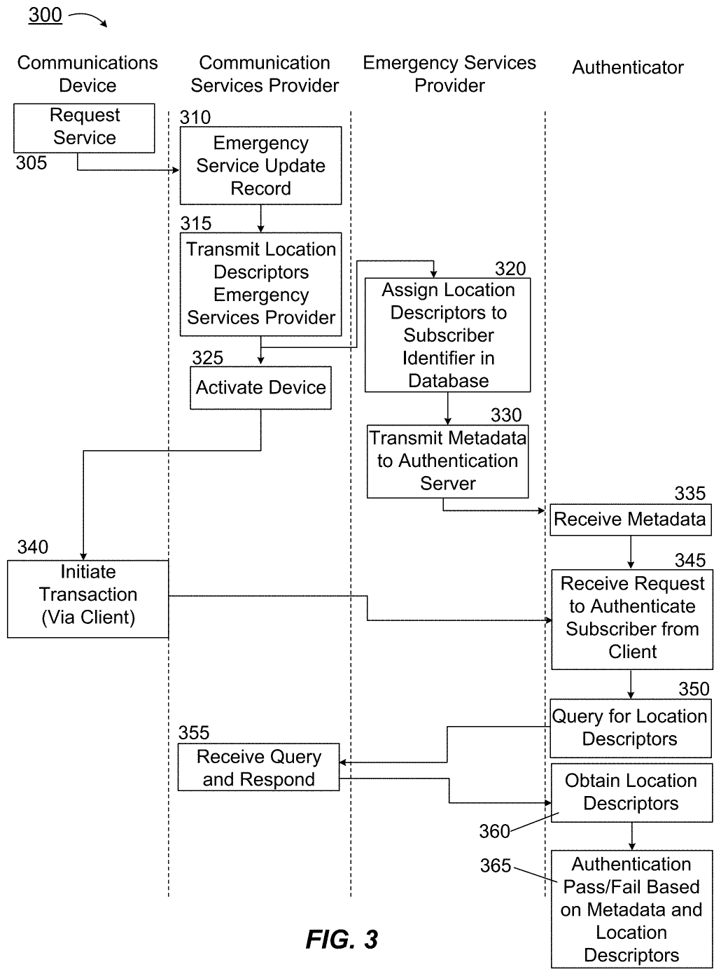

FIG. 3 is a diagram showing signal flow among a communications device, a services carrier, and emergency services provider, and an authenticator, according to an embodiment (300). In FIG. 3, a communications device, such as communications device 102 (of FIG. 1) operated by subscriber 205 (of FIG. 2A) may request service, for example at 305, from a communication services carrier. Responsive to such request, a communication services carrier may create one or more subscriber records, such as a subscriber identifier (e.g., a mobile telephone number) corresponding to subscriber location descriptors, such as name, street address, city or township, country, etc. of subscriber 205. At 315, location descriptors may be transmitted to an emergency services provider who may, in turn, enter location descriptors and the subscriber identifier into a database, such as at 320. At 325, in response to the emergency services provider indicating that location descriptors corresponding to subscriber 205 have been received and recorded, the communication services carrier may activate device 102.

At 330, perhaps upon request from an authenticator (e.g., authentication server 240 of FIG. 2A), the emergency services provider may transmit signals comprising metadata, such as one or more event statuses, to the authenticator. Event statuses may be accompanied by one or more record states, such as described in relation to FIG. 2B. At 335, received metadata from the emergency services provider may be stored in a memory accessible to an authenticator.

At 340, a subscriber, operating through a client, which may represent a bank or other financial institution, provider of premium entertainment content, health records provider, etc., may initiate a transaction via communications device 102. In response, such as at 345, an authenticator may receive a request to authenticate the subscriber, such as from a client server. At 350, the authenticator may, based on metadata signals received from the emergency services provider, query for location descriptors. It should be noted that although 350 is shown querying a single communication services provider, in some embodiments, 350 may be repeated, so as to query a number of communication services providers to determine which of such providers is currently actively providing service to communications device 102. At 355, the particular communication services provider may respond with location descriptors for subscriber 205 currently in possession of, or at least co-located with, device 102. At 360, the authenticator may obtain location descriptors and, utilizing metadata signals received at 335, determine whether an event status corresponding to subscriber location descriptors is “New,” “Inactive,” or “Updated.” Further, the authenticator may determine if record states correspond to “Active” or “Inactive” states. The authenticator may then, utilizing metadata signals from the emergency services provider and location descriptors provided by the communication services carrier(s) 260, determine whether subscriber 205 can be authenticated, or, conversely, cannot be authenticated.

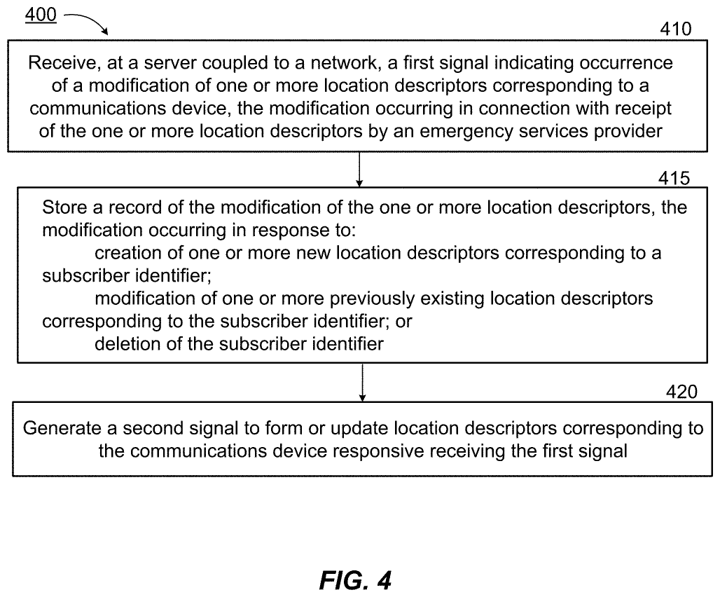

FIG. 4 is a flowchart showing operations performed by an authentication server that may access a subscriber database, according to an embodiment 400. In the embodiment of FIG. 4, the communications device and the authentication server, may refer to communications device 102, client server 225, and authentication server 240, although claimed subject matter is not limited in this respect. Rather, the communications device and servers of FIG. 4 may refer to numerous other processing entities of an authenticating system. It should be noted that the disclosed embodiments, such as the embodiment of FIG. 4, is intended to embrace numerous variations, including methods that may include actions in addition to those depicted in the figures, actions performed in an order different than those depicted in the figures, as well as methods including fewer steps than those depicted.

FIG. 4 may begin at 410, which includes receiving, at a server coupled to a network, a first signal indicating occurrence of a modification of one or more location descriptors corresponding to a communications device. The modification may occur in connection with receipt of one or more location descriptors by an emergency services provider. At 415, the method may continue by storing a record of the modification of the one or more location descriptors, in which the modification occurs in response to creation of one or more new location descriptors corresponding to a subscriber identifier. The modification may additionally occur in response to one or more previously existing location descriptors corresponding to the subscriber identifier or deletion of the subscriber identifier. The method may continue at 420, which may include generating a second signal to bring about formation or updating of location descriptors of a communications device in response to receiving the first signal.

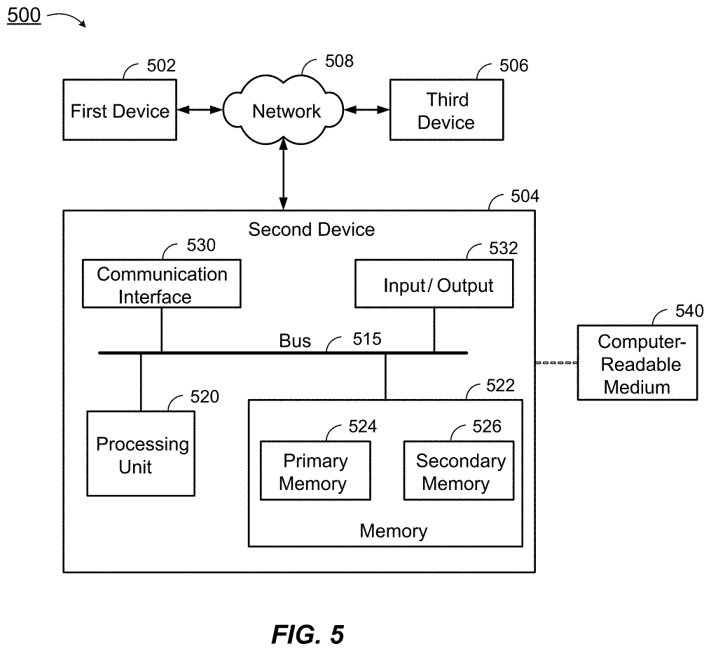

FIG. 5 is a diagram showing a computing environment, according to an embodiment 500. In the embodiment of FIG. 5, first and third devices 502 and 506 may be capable of rendering a graphical user interface (GUI) for a network device, such as server device 140 of FIG. 1, so that a subscriber utilizing a communications device (e.g., a mobile communications device) may engage in system use. Device 504 may potentially serve a similar function in this illustration. Likewise, in FIG. 5, computing device 502 (‘first device’ in FIG. 5) may interface with computing device 504 (‘second device’ in FIG. 5), which may, for example, also comprise features of a client computing device and/or a server computing device, in an embodiment that implements a client/server computing model. Processor (e.g., processing device) 520 and memory 522, which may comprise primary memory 524 and secondary memory 526, may communicate by way of a communication interface 630, for example. The term “computing device,” in the context of the present patent application, refers to a system and/or a device, such as a computing apparatus, that includes a capability to process (e.g., perform computations) and/or store electronic digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 504, as depicted in FIG. 5, is merely one example, and claimed subject matter is not limited in scope to this particular example.

In FIG. 5, computing device 502 may provide one or more sources of executable computer instructions in the form of physical states and/or signals (e.g., stored in memory states), for example. Computing device 502 may communicate with computing device 504 by way of a network connection, such as via network 508, for example. As previously mentioned, a connection, while physical, may be virtual while not necessarily being tangible. Although computing device 504 of FIG. 5 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 522 may comprise any non-transitory storage mechanism. Memory 522 may comprise, for example, primary memory 524 and secondary memory 526, additional memory circuits, mechanisms, or combinations thereof may be used. Memory 522 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 522 may comprise one or more articles utilized to store a program of executable computer instructions. For example, processor 520 may fetch executable instructions from memory and proceed to execute the fetched instructions. Memory 522 may also comprise a memory controller for accessing device readable-medium 540 that may carry and/or make accessible digital content, which may include code, and/or instructions, for example, executable by processor 520 and/or some other device, such as a controller, as one example, capable of executing computer instructions, for example. Under direction of processor 520, a non-transitory memory, such as memory cells storing physical states (e.g., memory states), comprising, for example, a program of executable computer instructions, may be executed by processor 520 and able to generate signals to be communicated via a network, for example, as previously described. Generated signals may also be stored in memory, also previously suggested.

Memory 522 may store electronic files and/or electronic documents, such as relating to one or more users, and may also comprise a machine-readable medium that may carry and/or make accessible content, including code and/or instructions, for example, executable by processor 520 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 520 may comprise one or more circuits, such as digital circuits, to perform at least a portion of a computing procedure and/or process. By way of example, but not limitation, processor 520 may comprise one or more processors, such as controllers, micro-processors, micro-controllers, application specific integrated circuits, digital signal processors, programmable logic devices, field programmable gate arrays, the like, or any combination thereof. In various implementations and/or embodiments, processor 520 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 5 also illustrates device 504 as including a component 532 operable with input/output devices, and communication bus 515, for example, so that signals and/or states may be appropriately communicated between devices, such as device 504 and an input device and/or device 504 and an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more communications devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a client server device and/or a communications device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a communications device and/or a client server device in various embodiments. Network devices capable of operating as a client server, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a communications device, as well as other types of devices, including between wired and/or wireless devices coupled via a wired and/or wireless network, for example, or any combination thereof. It is noted that the terms, server, server device, server computing device, server computing platform and/or similar terms are used interchangeably.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

The term electronic file and/or the term electronic document are used throughout this document to refer to a set of stored memory states and/or a set of physical signals associated in a manner so as to thereby, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a subscriber identity module (SIM) card, which, for example, may comprise a detachable or embedded smart card that is able to store subscription content of a subscriber, and/or is also able to store a contact list. It is noted, as previously mentioned, that a SIM card may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a communications device application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
receiving, at a server coupled to a network, a first signal indicating occurrence of a modification of one or more location descriptors corresponding to a communications device, the modification occurring in connection with receipt of the one or more location descriptors by an emergency services provider;
storing a record of the modification of the one or more location descriptors, the modification occurring in response to:
creation of one or more new location descriptors corresponding to a subscriber identifier;
modification of one or more previously existing location descriptors corresponding to the subscriber identifier; or
deletion of the subscriber identifier;
and
generating a second signal to form or update an electronic or digital identity of the communications device responsive to receiving the first signal.

2. The method of claim 1, further comprising:
generating one or more additional signals by the server coupled to the network, the one or more additional signals being utilized in a process of authenticating, authorizing, and/or verifying a subscriber conducting an electronic transaction.

3. The method of claim 1, wherein the location descriptors indicate a physical address associated with the communications device.

4. The method of claim 3, wherein the physical address comprises a street address.

5. The method of claim 1, wherein the communications device corresponds to a mobile cellular communications device, a fixed or mobile voice over Internet protocol (VoIP) communications device, or a wireline telephone.

6. The method of claim 1, wherein creation of the one or more new location descriptors corresponding to the subscriber identifier is in response to a subscriber entering into an agreement to obtain services from a communication services carrier.

7. The method of claim 1, wherein modification of the one or more previously existing location descriptors corresponding to the subscriber identifier is responsive to a subscriber initiating a porting operation to transfer a subscriber identifier from a first communication services carrier to a second communication services carrier.

8. The method of claim 1, wherein deletion of the subscriber identifier is responsive to a communication services carrier initiating a service-disconnection event.

9. The method of claim 1, wherein the subscriber identifier corresponds to a telephone number of the communications device.

10. The method of claim 1, wherein the emergency services provider corresponds to an E911 services provider.

11. The method of claim 1, wherein storing the record of the modification of the one or more location descriptors occurs within a time period of between 1.0 seconds and 1.0 hours of the occurrence of the modification.

12. A server, coupled to a communications network, comprising:
at least one processor coupled to at least one memory device to:
initiate reception from the communications network of a first signal to indicate occurrence of a modification of one or more location descriptors corresponding to a communications device, the modification of the one or more location descriptors to be in connection with receipt of the one or more location descriptors by an emergency services provider;
initiate storage of a record of the modification of the one or more location descriptors, the modification occurring in response to at least one of:
creation of one or more new location descriptors corresponding to a subscriber identifier;
modification of one or more previously existing location descriptors corresponding to the subscriber identifier; or
deletion of the subscriber identifier;
and to
generate a second signal to form or update an electronic or digital identity of the communications device responsive to receipt of the first signal.

13. The server of claim 12, wherein the one or more location descriptors are to indicate a street address.

14. The server of claim 12, wherein the communications device is to correspond to a mobile cellular communications device or to a voice over Internet protocol (VoIP) communications device.

15. The server of claim 12, wherein creation of the one or more new location descriptors corresponding to the subscriber identifier is responsive to a subscriber entering into an agreement to obtain services from a communication services carrier.

16. The server of claim 12, wherein modification of the one or more previously existing location descriptors corresponding to the subscriber identifier is in response to a subscriber initiating an operation to port the subscriber identifier from a first communication services provider to a second communication services provider.

17. The server of claim 12, wherein deletion of the subscriber identifier corresponds to a communication services carrier initiating a service-disconnection event.

18. The server of claim 12, wherein the subscriber identifier corresponds to a telephone number of the communications device.

19. The server of claim 12, wherein the emergency services provider corresponds to an E911 services provider.

20. The server of claim 12, wherein storage of the record of the modification of the one or more location descriptors occurs within a time period of between 1.0 seconds and 1.0 hours after the modification of the one or more location descriptors.

21. An article comprising:
a non-transitory storage medium having instructions stored thereon executable by a special-purpose computing platform to:
initiate reception, from a communications network, of a first signal indicating occurrence of a modification of one or more location descriptors corresponding to a communications device, the modification occurring in response to receipt of the one or more location descriptors by an emergency services provider;
initiate storage of record of the modification of the one or more location descriptors, the modification occurring in response to:
creation of one or more new location descriptors corresponding to a subscriber identifier;
modification of one or more previously existing location descriptors corresponding to the subscriber identifier; or
deletion of the subscriber identifier;
and
generate a second signal to form or update an electronic or digital identity of the communications device responsive to receipt of the first signal.

22. The article of claim 21, wherein creation of the one or more new location descriptors corresponding to the subscriber identifier is responsive to a subscriber entering into an agreement to obtain services from a communication services carrier.

23. The article of claim 21, wherein modification of the one or more previously existing location descriptors corresponding to the subscriber identifier is in response to a subscriber initiating an operation to port the subscriber identifier from a first communication services provider to a second communication services provider.

24. The article of claim 21, wherein deletion of the subscriber identifier corresponds to a communication services carrier initiating a service-disconnection event.
